(19) United States
(12) Patent Application Publication
(10) Pub. No.: US 2005/0212525 A1
(43) Pub. Date: Sep. 29, 2005

(54) Advanced 24/7 differential oscilloscope with remote access and security features for detection of neutral to earth voltage

(76) Inventors: David Martin Rogers, Surrey (CA); Sebastian Daniel Rogers, (US)

Correspondence Address: DAVID MARTIN ROGERS, 5756 149TH STREET, SURREY, B.C., BC, V3S 8W7, CA

(21) Appl. No.: 10/718,932

(22) Filed: Nov. 21, 2003

(51) Int. Cl. G01R 31/08

(52) U.S. Cl. 324/522

(57) ABSTRACT

A method and device displays and saves 24 hours a day and all year round short and long term duration neutral to earth voltage events which occur in the proximity of animals. The detailed real time display and past event files may be viewed remotely and securely by an expert who using advanced diagnosis may determine low cost solutions to neutralize these damaging to animals neutral to earth voltage events.

### FIELD OF THE INVENTION

The present invention relates to a 24 hour all year round monitoring system of short and long term neutral to earth voltage events and allows an expert in mitigation of these events remote access to the monitoring system in both real and post time and securely.

### BACKGROUND OF THE INVENTION

Animals often have very much lower epidermal electrical resistances than humans. Consequently they are very sensitive to low electrical currents. Dry human skin is often over 10 million ohms whereas the epidermal surfaces of cows are often less than 400 ohms. Consequently cows feel low electrical current as we would if we placed our tongue across the terminals of for example a 9V battery.

This sensitivity to very low amounts of electricity has lowered productivity and the health of farm animals. It has also damaged the health of non farm animals such as horses and fish. Some dairy farmers have lost their livelihood because of short and long term duration Neutral to Earth Voltage referred to from here on a NEV. The term stray voltage covers NEV as well as animal contact voltage which is also called tingle voltage. The device of this current invention also may measure stray voltage and tingle voltage.

Animals feel electrical current. However as they have an electrical resistance measuring voltage will indicate the presence of current by Ohm's Law. Using an advanced high speed oscilloscope to measure voltage the events captured have specific signatures which an expert will read and interpret. These signatures offer vital clues as to the origins and ultimate remediation of damaging NEV.

When cows are milked their teats are connected to milking machines and as the milk flows from them it may form a direct path with the utility neutral as the stainless steel milk line pipes which carry this milk is bonded at the electrical service panel to the neutral. In North America the farm's secondary service neutral is connected to the utilities primary system neutral. Cows across North America and in other parts of the world are in contact with electric utilities neutral lines.

In the 1970's work was carried out to help reduce animal contact with the utility neutral. On dairy farm milking parlours copper and steel equipotential grounding grids where installed in freshly poured new concrete parlour floors. This helped equalize animal contact voltage and did reduce NEV exposure to animals.

However these grids may not have been adequately installed or may have broken up over the years leaving areas where animal contact NEV occurs. Also when cows entered and left the parlours as they stepped in and out of the equipotential grounding grid they experienced NEV. This was often enough to affect their milking and milk out rates and could lead to forms of mastitis and sickness in the herd.

These grounding grids often actually attract electrical currents to the milking parlours. As they have a low electrical resistance electrical return paths may find their way to it. During milking this may be painful to cows and long and short term NEV may enter them due to the differentials in electrical resistances between various places on the farms wiring circuits. In summer ground rods may dry out and their electrical resistance may significantly increase. If an electric fence has a poor ground on its controller very high electrical short term NEV events may head straight to the low ground resistance milk parlour and cows may be constantly shocked.

Another but not commonly known problem with dairy milking parlour grounding grids is that they often create parallel circuits. These capture electric current between the grid which is carried via the #6 copper bonding wire stipulated in the NEC and connected to the farm's electrical service ground. The earth forms the lower part of the parallel circuit. Cows can die with currents of 10 mA flowing through them but these ground-loop parallel circuits may have as much as +400 mA in them.

When farms and other places are tested for NEV and animal contact voltage its customary to do these tests using the 5 ms/division (DIV) scale of oscilloscopes or to use simple multimeters. FIG. 1 shows that on the 5 ms/DIV scale most oscilloscopes have very low sampling rates. Consequently many experts may have used this scale and may have failed to find short term NEV events which may harm animals.

This has lead to confrontation between those testing for NEV and animal contact voltage and farmers. The farmers insisted there was a problem and those testing insisted there wasn't one. Also the majority of site tests often lasted minutes or hours and many NEV events were never seen or recorded.

The inventors of this current invention have tested over 1,500 dairy farms for neutral to earth voltage using the Fluke 105B and also 199C Scopemeter's. The inventors could not understand why despite seeing no NEV events farmers complained their cows still had symptoms associated with it. Since applying this current invention to the same farms other oscilloscopes where used on several electrical problems have been identified and solved which has lead to complete mitigation of NEV problems on farms.

Using the current remote access differential oscilloscope invention, one farmer added over $1.5 million to his cash flow and another added 1.5 gallons of average milk production per day per Jersey breed cow.

New equipment installed on farms may often cause significant NEV and older equipment may suddenly break down causing it too. Unless the farm is constantly monitored and by a high speed oscilloscope system farms may always remain insecure and open to future damage to NEV.

Much of the time spent by experts testing farms for NEV is used in travel and logistics to and from remote farm locations. However in the embodiment of this current invention the farmer simply plugs it in, connects the probes to the testing areas and switches it on and from there on his farm is being constantly monitored by an expert far away.

The current invention is seen to offer a radical solution for farmers with animals being affected by NEV and guarantee future problems never occurring.

### OBJECT OF THE INVENTION

An object of the present invention is therefore to neutralize stray current that can flow through the body of an animal(s) bred or kept in a farm building.

An object of the present invention is therefore to test NEV short and long term events 24 hours a day every day of the year and to enable an expert to have complete remote access in both real and past time of all NEV events. That the oscilloscope used for testing will show short time events on the 5 ms/DIV scale of 10 MS/s and the expert may remotely alter scales to verify remedial actions to eliminate NEV has worked successfully.

### SUMMARY OF THE INVENTION

More specifically, in accordance with the present invention, there is provided a device for sensing neutral to earth voltage events and displaying NEV events on a display both at this device and on a remote display comprising:
means for sensing short duration and long duration neutral to earth voltage events
means for differential measurement of said neutral to earth voltage events
means for capturing triggered events which exceed a set-point and of saving them to files
means for connecting this device to another remote computer and displaying both real time and historic waveform neutral to earth voltage events
means for securing the software of this computer oscilloscope device of this invention to prevent third parties stealing the SvScope software and or sabotaging the device
means for securely housing the entire computer oscilloscope system in a chrome plated checker-plate case which is sealed by security screws and steel clamps
means for connecting a remote ground rod used as an earth reference voltage and of connecting the neutral bonded system to the oscilloscope system

The objects, advantages and other features of the present invention will become more apparent upon reading of the following non restrictive description of preferred embodiments thereof, given by way of example only with reference to the accompanying drawings and charts.

### BRIEF DESCRIPTION OF THE DRAWINGS

In the appended drawings:

FIG. 1 is a schematic diagram illustrating neutral to earth voltage resulting from two neutral circuits being connected together.

FIG. 2 illustrates between which two points the SvScope differential oscilloscope is connected. It also shows one way cows be exposed to electrical return paths.

FIG. 3 is an oscilloscope print out of farm which is not electrically isolated from the utility system neutral.

FIG. 4 is an oscilloscope print out of the same farm as in FIG. 3 but after a Dairyland Electrical Industries Variable Threshold Neutral Isolator isolated the farm from the system neutral. The transients events are picked up by the differential oscilloscope of this present invention and is remotely accessible for Advanced Diagnostics to solve these and other events. After the remote diagnostic services have been applied all that is left on the farm is a horizontal straight line with near zero Neutral to Earth Voltage.

FIG. 5 describes how this current invention offers very high sampling rates and in particular between 1 ms/division to 10 ms per division. Events seen on these scales are felt by a significant portion of cows.

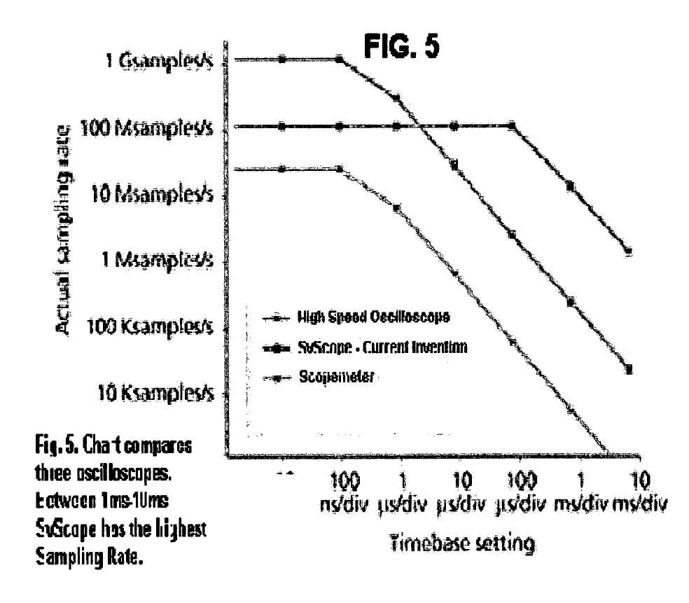

FIG. 6 Schematic of Differential Oscilloscope hardware.

FIG. 7 Schematic of Software covering the Operating System for SvScope and the Network Security.

FIG. 8 Illustrates sketch views of the differential oscilloscope system which may be wall mounted.

### DETAILED DESCRIPTION OF THE PREFERRED EMBODIMENTS

In the different figures of the appended drawings, the corresponding elements are identified by the same reference numerals.

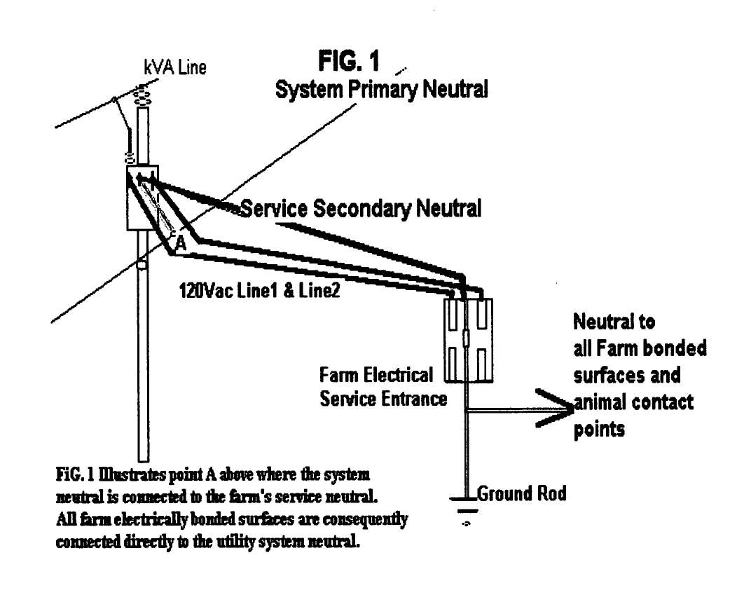

In North America and other parts of the world, the structure of the electric distribution networks such as illustrated in FIG. 1 causes the flow of a small portion of the primary supply alternating current toward the ground This represents the unbalanced differential voltage between Line 1 and 2. The cause for this unbalance is that as farm equipment switches on it pulls power off one of the Lines (1 or 2). As power is pulled off that line the voltage drops from its rated 120 Vac on a standard single phase system. The difference between the voltage on line 1 and line 2 is this small portion of alternating current mentioned above. This current may return to its source which is the pole mounted distribution transformer through the earth.

However power supply imbalances also occur off the system primary neutral. Each farm and secondary service is connected to the system neutral. Each of these services injects their imbalances into the system neutral which in turn then contribute to alternating current being injected into off site farms in the area.

The two neutral return systems; (a) the primary system neutral along the street and (b) a farm's secondary service neutral can ‘never’ balance simply because they are two distinct circuits and are tied together.

Utilities may install a solid state reconnection switch device which opens the connection between the primary and secondary neutrals at the farm's power source which is the pole mounted distribution transformer. This device is called the Dairyland Electrical Industries Variable Threshold Neutral Isolator (DEI VT-NI). He current inventor has successfully installed over 170 of these devices. The inventor recommends his customer's who purchase his SvScope first have their electric utility install this device. The DEI VT-NI always fails closed thereby re-establishing continuity between the system and services neutrals which in the case of a serious electrical fault will save the farm from serious power sudden faults by blowing the main system fuse at the distribution transformer.

In FIG. 1 we see that an un-isolated farm has off farm system neutral voltage (coming in from other farms and utility customers) being injected to all bonded and grounding surfaces on the farm.

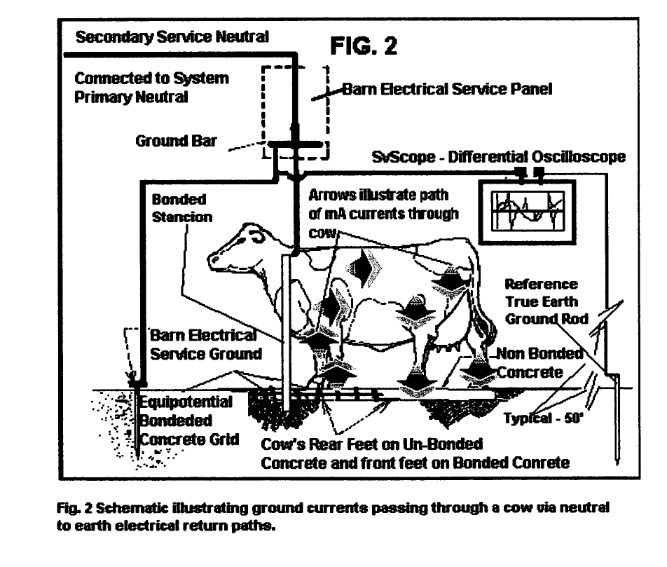

In FIG. 2 we see how even if electrical equipotential grounding grids are installed in for example milk parlours, as a cow initially steps onto or off of them electrical currents enters her body. This figure also describes between which points this current invention's testing probes are connected. Typically the milk parlours stainless steel milk line is where the line-in voltage is measured and the remote and isolated ground rod. However other line-in points may also be selected.

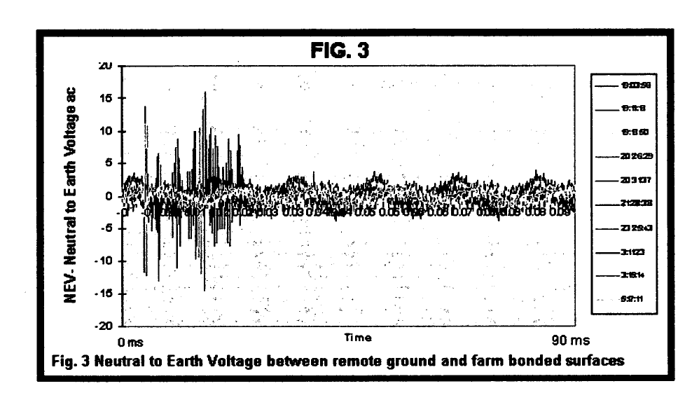

FIG. 3 shows typical farm neutral to earth voltage without neutral isolation. This electricity is found in the milk and may be felt at cow's teats inevitably causing them serious discomfort and health issues. The voltage transient spikes are generally caused by on farm equipment but may also come from off-site by way of the system neutral connection on un-isolated farms.

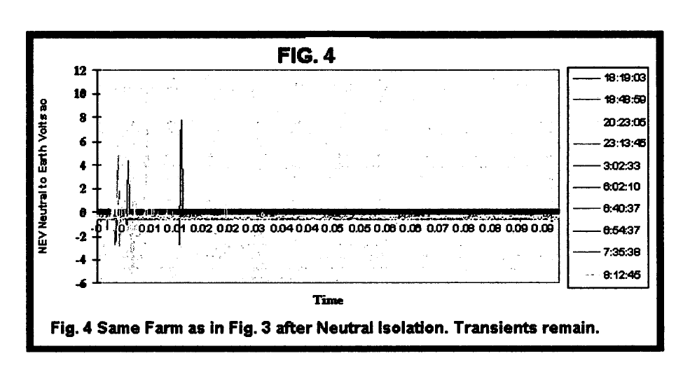

When a farm is successfilly isolated from the system neutral we may see typical neutral to earth oscilloscope readings as in FIG. 4. Note voltage transient spikes will still be ever present along with many forms of power quality issues. Unless a very fast oscilloscope is used for diagnosing these issues they may never be resolved. The current inventors have witnessed farms which having been successfilly isolated from the system neutral and having had their secondary service neutral returns balanced, farmers still complaining of stray voltage symptoms with their cows. These symptoms are quite classic and range from; reluctance to enter the milk parlour, kicking during milking, not letting down their milk and serious health problems such as mastitis and fecal colliform plus poor milk yields and feed conversion ratios and of course increased veterinary bills.

Despite all these ongoing symptoms the oscilloscope the inventors had used which was the Fluke 105B failed to detect any neutral to earth voltage events. The inventors where convinced they needed a more advanced oscilloscope.

On the market are several PCI and PC board type oscilloscope modules. However the price of these was prohibitive when their speeds exceed 100,000 samples per second. The challenge then became how to find a PC based oscilloscope module which had the required speed and resolution to show NEV events and particularly very high speed short duration NEV events. After many months of testing many oscilloscope modules and spending significant money on this quest one was found.

FIG. 4 describes where most oscilloscopes fail to show high speed events on the scale stray voltage testers use which is the 5 ms per division scale. The SvScope module however shows very fast events on this scale. It can be seen that the scopemeter on the bottom line of the chart, fails badly to describe such events on this scale. Since using the SvScope module on farms the inventors have discovered many very serious electrical events on farms and have saved a number of farms who where doing so poorly that they were almost out of business.

The Scopemeter the inventors had used is most accurate at displaying short term NEV events on the 100 micro-second per division scale. However on many farms the SvScope advanced differential oscilloscope of this current invention has shown 1,000's of serious events but the Scopemeter even on the most accurate scale failed to see one such event.

Essentially what defines this current invention is the complete combination of everything put together which is a new creation. It's the advanced oscilloscope module which is shown in FIG. 4 to excel its counterparts; it's the differential unit module which insures an accurate remote ground to neutral alternating current voltage reading; it's the high powered computer which has a CPU with over 2 GHz in speed, with 40 GB high speed hard drive and motherboard with high cache and at least 256 MB of RAM; it's the good quality BNC cable line leads to the oscilloscope; it's the ability of this whole advanced differential oscilloscope to have remote access by way of a modem; either phone line, cable or wireless; it's the customized SvScope for Windows software specially designed to run the oscilloscope module; it's the Windows based Operating System and typically Win Xp which is entirely customized and made to be highly secure by removing and disabling and password encrypting many of it's features thereby preventing third parties from unscrupulously stealing the essential features of this current invention; its how the entire system is housed in a NEMA II dust and insect proof stainless steel case having an LCD screen mounted on it's front and pull-down and hinged tray for the keyboard and mouse with all external connections on the side, all these features constitute the essential embodiment of this current invention.

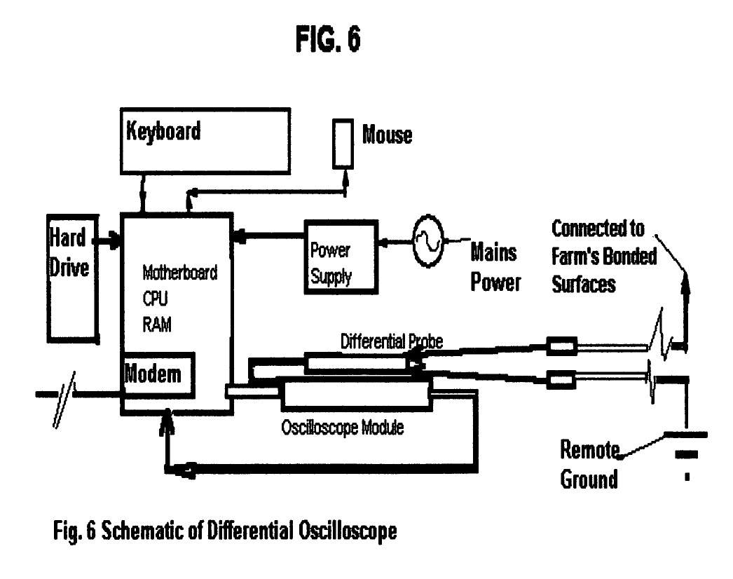

FIG. 6 is a schematic sketch showing the main hardware component modules.

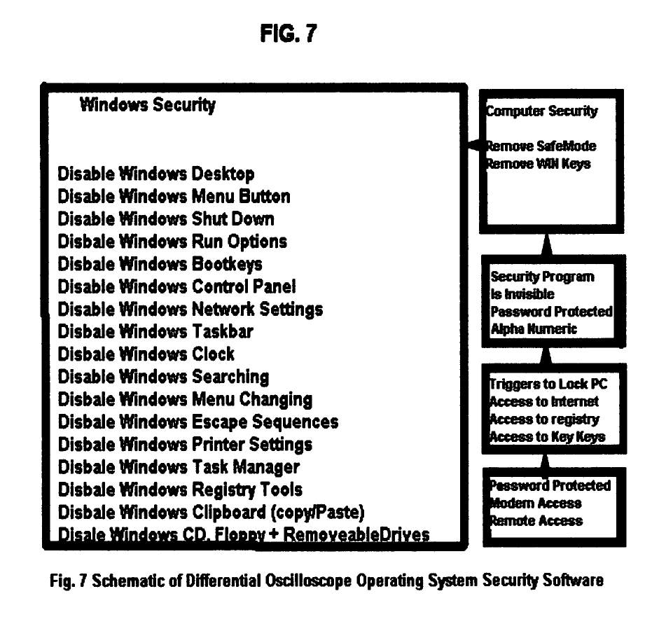

An essential feature of this current invention is it's secure software features. These are listed in FIG. 7.

The following Windows Xp features are disabled;
Desktop
Menu Button
Shut Down
Run Options
Boot Keys
Control Panel
Network Settings
Taskbar
Clock
Searching
Menu Changing
Escape Sequences
Printer Settings
Task Manager
Registry Tools
Clipboard (copy/paste)
CD, Floppy and Removable Drives
Windows Keys on the Keyboard

The following Windows Xp features are removed:
Windows Safe Boot/Mode

Triggers which lock up the computer operating the advanced differential oscilloscope:
Internet Access
Registry Access
Key keys Access
(Miscellaneous add-ons)

Passwords:
Bios
Modem Access
Remote Access Software
Entire Operating System in real Time—Windows Lock.

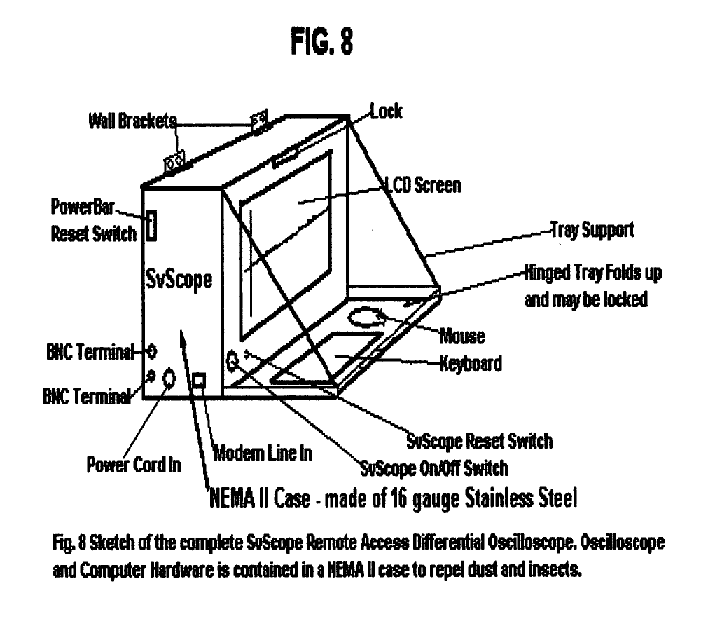

The entire system of this current invention is housed in a NEMA II case made of 16 gauge stainless steel and is described referring to FIG. 8. The case side panel houses all the exterior line connections which include;
Two BNC cable terminals; Power cord inlet and Modem line-in.

On the same panel is a reset button for the power tap TVSS bar which offers some degree of protection to this system from power surges.

The front panel houses the main system on/off switch and computer module reset button plus the flat LCD screen.

A hinged panel covers the front panel with support cord lines one either end. This front panel cover has a lock at its top. Upon unlocking the panel is lowered and it has a fixed mounted keyboard and mouse. The mouse may be un-hitched and used freely. The entire case and system may be wall mounted at a convenient work height.

Although the present invention has been described hereinabove by way of preferred embodiments thereof, these embodiments can be modified at will, within the scope of the appended claims, without departing from the spirit and nature of the present invention.

Figures are attached on appended 8 pages.

1. A device for displaying short and long duration neutral to earth voltage events comprising:
means for sensing neutral to earth voltage in the immediate area of animals susceptible to it or be affected by it and comprising a computer oscilloscope device, a computer with either a CRT or LED monitor and a differential probe unit all connected together and forming one unit,
means for sensing neutral to earth voltage events at speeds typically at 50 MS/s for single shot signals and up to 5 GS/s for repetitive signals and with a high resolution of typically 12 bits or higher,
means for sensing neutral to earth voltage events on the 5 ms/division scale with a real time sampling rate greater than 100 Ks/s and ideally 10 MS/s or greater on this scale,
means for sensing neutral to earth voltage with trigger modes in free run with auto, repeat and single pre and post trigger ±100% and storing events as files on the computer and on selectable scales ranging from 5 billionths of a second per division up several seconds per division,
means for sensing neutral to earth voltage with voltage ranges ±50 mV to ±20 V in nine ranges,
means for sensing neutral to earth voltage with overload protection ±100V,
means for sensing neutral to earth voltage with input impedance of 1M ohm and with coupling AC and DC,
means for sensing neutral to earth voltage with two channels and one with external trigger,
means for differentially sensing voltage between the neutral and remote earth typically with a rise time of 14 billionths of a second and with a measurement accuracy of +/− 2%,
means for sensing neutral to earth voltage differentially with an external or internal power adapter power supply of 9V DC/60 mA power supply
means for securely housing the entire oscilloscope monitoring system of this invention within a locked dust and insect proof enclosure using security screws and locks.

2. A device for conveying information from claim 1 to a remote user:
means for connecting the computer system of claim 1 to a remote computer with display either CRT or LED and typically using a modem to modem, cable modem to cable modem or network card to network card or by wireless communication or fiber optics or other means of communication,
means for conveying information between the oscilloscope computer system of claim 1 to another computer or computers and not excluding existing telegraphic or wireless methods.

3. A device for enabling the oscilloscope computer system of claim 1 to function with claim 2 in a secure manner:
means for capturing, displaying and saving short and long term neutral to earth voltage events over a windows operating system and called SvScope for Windows,
means for securing windows operating system disabling several windows functions thereby restricting site user access to the entire computer based oscilloscope system such that the remote expert only has complete administrator privileges over the oscilloscope system,
means for remote access connecting the device of claims 1 and 2 to a remote computer securely using an encrypted password in both real and historic time and in that an expert in a remote location may use advanced diagnosis to work out low cost methods to reduce and eliminate short and long term neutral to earth voltage.

4. A computer oscilloscope online monitoring system according to claims 1, 2 and 3 comprising:
means for connecting the device of claim I between any bonded neutral surfaces to a remote and a reference ground rod and typically but not exclusively using coaxial BNC connector type computer cable,
means for moving the connector cable to various locations in contact with both neutral and animal contact surfaces or in the immediate area of animals susceptible to or be affected by the neutral to earth voltage,
means for connecting a 500 Ohm electrical resistor between the differential probes of claims 1 and 4 in a manner that this connection may be opened or closed.
